(19) United States
(12) Patent Application Publication
(10) Pub. No.: US 2018/0330705 A1
(43) Pub. Date: Nov. 15, 2018

(54) SYSTEM AND METHOD FOR HAPTIC INSTRUMENTAL ELECTRONIC DEVICE

(71) Applicant: Wojciech Karim Palmowski, Chicago, IL (US)

(72) Inventor: Wojciech Karim Palmowski, Chicago, IL (US)

(21) Appl. No.: 15/946,463

(22) Filed: Apr. 5, 2018

Related U.S. Application Data
(60) Provisional application No. 62/482,334, filed on Apr. 6, 2017.

(51) Int. Cl. G10H 1/34; G06F 3/01; G10B 3/12; G06F 3/041

(52) U.S. Cl. CPC G10H 1/346; G06F 3/016; G10H 2220/311; G06F 3/0412; G10B 3/12

(57) ABSTRACT

Embodiments of the disclosure provide a haptic instrumental device comprising an electronic device having a display screen, one or more keys provided along the display screen, and one or more brackets coupled with the one or more keys and secured to the electronic device. Further, the one or more keys may include one or more capacitive nibs that, when pressed against the display screen, cause the electronic device to receive an input.

### BACKGROUND

Musical instruments, including pianos and wind instruments, are generally bulky devices that require storage space. In addition, many musical instruments can be expensive. For example, pianos are large, acoustic, stringed musical instruments that function by the use of strings that are struck by padded hammers. Pianos are played using a keyboard, i.e., a row of keys or small levers that an operator may press down or strike with their fingers and thumbs of both hands to cause the hammers to strike the strings. The volume produced by a piano may be dependent upon a variety of factors. For instance, the volume and/or sound produced by a piano may be dependent upon variations in an operator's touch and/or the pressure applied to the keys. In effect, the greater the velocity used to press a key, the greater the force applied to the strings by the hammer, and thus, a louder or more intense sound and/or note is produced.

In general, an acoustic piano usually includes a case surrounding a soundboard and metal strings strung under great tension on a heavy metal frame. As discussed above, pressing one or more keys on the piano's keyboard causes a padded hammer, typically padded with a firm felt, to strike the strings and produce the desired sound or note. The hammer may then rebound to its starting position. However, the strings may continue to vibrate at their resonant frequency. These vibrations are transmitted through a bridge to a soundboard that amplifies the sound by more efficiently coupling the acoustic energy to the surrounding air. Further, when the key is released, a damper may stop the strings' vibration, effectively ending the sound.

Wind instruments also operate through a vibration-based sound production and are typically grouped into two families: brass instruments, e.g., horns, trumpets, trombones, euphoniums, and tubas, and woodwind instruments, e.g., recorders, flutes, oboes, clarinets, saxophones, and bassoons. With regard to brass instruments, a player's lips vibrate, causing the air within the instrument to vibrate. Alternatively, in woodwind instruments the player causes a reed to vibrate and, in effect, agitates a column of air. In other woodwind instruments, the player may blow over a fipple, across an open hole against an edge, or blow across an edge of an open hole to produce a sound.

Wind instruments generally operate by an operator blowing air into a mouthpiece, and changing one or more characteristics of a vibrating column, e.g., by changing the length of the vibrating air column, changing the length of the tube through engaging valves that route air through additional tubing, or changing a frequency of vibration through opening or closing holes in the side of the tube. For example, by increasing an overall tube length, the pitch of the instrument can be lowered. This is a common characteristic among most brass instruments. In other instances, the length of the vibrating air column may be altered by lengthening and/or shortening the tube using a sliding mechanism, e.g., as done during use of a trombone. In other instances, one or more holes strategically placed along a vibrating column can be closed or partially closed with a user's fingers by pressing a key that may, by extension, close a hole or alter the length of the vibrating air column that air passes therethrough, e.g., as done during use of a trumpet. These changes in the vibrating air column is utilized with most woodwind instruments.

In recent years, the sound vibrations created by instruments such as pianos and wind instruments have been reproduced through the use of electronic instruments, such as electronic keyboards and electronic wind instruments. However, such instruments do not necessarily eliminate issues associated with many traditional instruments. For example, such electronic instruments are still bulky, expensive, and require sufficient storage space. Still further, additional options for “playing instruments” have become available through applications (or “apps”) on tablets and other electronic devices, wherein the keys of an instrument are displayed on the screen of the electronic device. However, these types of instrument applications are innately different than real life instruments and do not provide the haptic feedback necessary for students and professionals alike to obtain meaningful practice with such devices.

In addition, current options available in apps, with the aforementioned simulated keys on a screen, can make it difficult to determine the correct key to press. In addition, many of the apps lack the physical and dynamic experience of hitting and/or pressing a traditional piano or wind instrument key. As follows, such applications fail to provide a sound variable and are typically not dependent upon the nature of the force applied to the simulated keys, e.g., a velocity, pressure, etc.

Good electronic options for keyboards and other musical instruments should closely emulate the tactile response of traditional instruments and, at the core, promote a broader access to musical instruments and musical education. For musicians, the product may easily become a portable extension of the ubiquitous Tablet Computer or Smart Phone. Although there is no substitute for a “traditional” instrument, such as the piano or French horn, it would be beneficial to have a portable and cost effective device that could more closely emulate the properties and feedback of playing a traditional instrument. Further, a device capable of detecting a velocity and/or pressure of the force applied thereto and providing a feel of a traditional instrument is desired.

### SUMMARY

Some embodiments provide a haptic instrumental device comprising an electronic device having a display screen, one or more keys provided along the display screen, and one or more brackets coupled with the one or more keys and secured to the electronic device. In this embodiment, the one or more keys include one or more capacitive nibs that, when pressed against the display screen, cause the electronic device to receive an input.

In some embodiments, the one or more keys measure at least one variable by the use of a change in a capacitive conductance. Illustratively, the one or more keys provide a capacitive conductance to the electronic device. Further, the at least one variable may comprise a velocity of the keys, a pressure applied to the electronic device, a contact area, and/or a duration that the one or more capacitive nibs contact the display screen.

Other embodiments provide a haptic instrumental device comprising an electronic device having a display screen, one or more keys and/or a mouthpiece provided along the display screen, and one or more brackets coupled with the one or more keys and/or mouthpiece and secured to the electronic device. The one or more keys may include one or more capacitive nibs that, when pressed against the display screen, cause the electronic device to receive an input.

### DESCRIPTION OF THE DRAWINGS

FIG. 1 is a top perspective view of a haptic instrumental device in the form of a keyboard kit secured to an electronic device;

FIG. 2 is an exploded top perspective view of the keyboard kit of FIG. 1;

FIG. 3 is a top perspective view of the keyboard kit of FIG. 1 assembled and removed from the electronic device of FIG. 1;

FIG. 4 is a top perspective view of another haptic instrumental device in the form of a keyboard kit secured to an electronic device;

FIG. 5 is another top perspective view of the haptic instrumental device of FIG. 1 with a user's hands ready to play the device;

FIG. 6 is an exploded top perspective view of multiple keys of the keyboard kit of FIG. 1;

FIG. 7 is a top plan view of the keyboard of FIG. 2;

FIG. 8 is a top plan view of the haptic instrumental device of FIG. 1;

FIG. 9 is a top perspective view of multiple keys of the keyboard kit of FIG. 1;

FIG. 10 is a side elevational view of the keys of FIG. 9;

FIG. 11 is a top plan view of the keys of FIG. 9;

FIG. 12 is a front elevational view of the keys of FIG. 9;

FIG. 13 is a cross-sectional view of the keys of FIG. 9 taken generally along the lines 13-13 of FIG. 11;

FIG. 14 illustrates two different keys for use with the haptic instrumental device of FIG. 1 from a top plan view, a side elevational view, and a front elevational view;

FIG. 15A is a side elevational view of a schematic of a key in a first non-depressed position;

FIG. 15B is a side elevational view of a schematic of the key of FIG. 15A in a second position upon depression with a first force;

FIG. 15C is a side elevational view of a schematic of the key of FIG. 15A in a third position upon depression with a second force;

FIG. 15D is a side elevational view of a schematic of the key of FIG. 15A in a fourth position upon depression with a third force;

FIG. 16 is a top perspective view of another haptic instrumental device in the form of a keyboard kit attached to an electronic device such as a tablet;

FIG. 17 is a top perspective view of another haptic instrumental device in the form of a wind instrument kit having a plurality of buttons and a mouthpiece attached to an electronic device;

FIG. 18 is a bottom elevational view of the haptic instrumental device of FIG. 17;

FIG. 19 is a top perspective view of a plurality of five different sized haptic instrumental devices with varying numbers of buttons similar to the one shown in FIG. 17;

FIG. 20 is a perspective view of various portions of a wind instrument kit having a plurality of buttons and a mouthpiece;

FIG. 21 is a top plan view of another embodiment of a wind instrument kit;

FIG. 22 is an exploded perspective view of another embodiment of an haptic instrumental device;

FIG. 23A is a top plan view of a button of the wind instrument kit of FIG. 17;

FIG. 23B is an exploded view of the button of FIG. 23A;

FIG. 23C is a perspective view of the button of FIG. 23A;

FIG. 23D is a side elevational view of the button of FIG. 23A;

FIG. 23E is a cross-sectional view of the button of FIG. 23A taken generally along the lines 23E-23E of FIG. 23A;

FIG. 24 is a top plan view of another embodiment of a haptic instrumental device comprising a wind instrument kit and an electronic device;

FIG. 25 is a top plan, exploded view of the haptic instrumental device of FIG. 24

FIG. 26 is a top plan view of another embodiment of a haptic instrumental device comprising a wind instrument kit and an electronic device in an assembled configuration;

FIG. 27 is a top plan view of another embodiment of a haptic instrumental device comprising a wind instrument kit and an electronic device;

FIG. 28 is a top plan view of yet another embodiment of a haptic instrumental device comprising a wind instrument kit and an electronic device;

FIG. 29 is a top, front, right perspective view of still another embodiment of a haptic instrumental device comprising a wind instrument kit and an electronic device;

FIG. 30 is a bottom, front, right perspective view of the haptic instrumental device of FIG. 29;

FIG. 31 is a cross-sectional view of one example embodiment of a mouthpiece assembly;

FIG. 32 is a top, front, left perspective view of yet another embodiment of a haptic instrumental device comprising a trumpet kit and an electronic device; and

FIG. 33 is a top, front, left perspective view of still another embodiment of a haptic instrumental device comprising a reed wood instrument kit and an electronic device.

### DETAILED DESCRIPTION

Before any embodiments of the invention are explained in detail, it is to be understood that the embodiments disclosed herein are not limited in application to the details of construction and the arrangement of components set forth in the following description or illustrated in the following drawings. The embodiments disclosed herein are capable of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments disclosed herein are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Tactile haptic feedback is common in cellular devices, and handset manufacturers are including different types of haptic technologies in manufactured devices. In most cases, the haptic feedback may be in the form of a vibration that is responsive to a touch. Some handset manufacturers also use haptic feedback technology on different types of touch-screen car navigation devices, along with stereo units. Technology employing touch screens that provide haptic feedback have been around since the early 2000's.

Surface haptics may refer to the production of variable forces in response to a user's finger as it interacts with a surface, such as a touchscreen. In such an instance, the device uses electrostatic technology to control the in-plane forces experienced by a fingertip, as a programmable function of the finger's motion. Some tablets also use ultrasonic technology to modulate the slipperiness of a glass touchscreen, as if a user's finger is floating on a cushion of air.

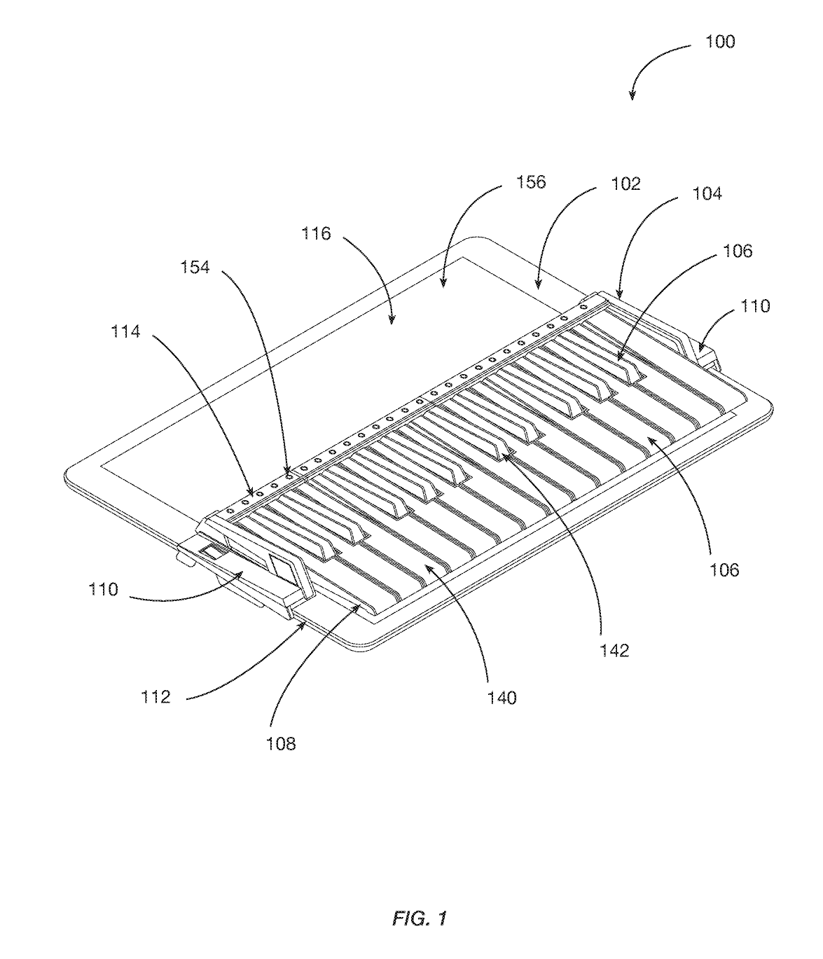

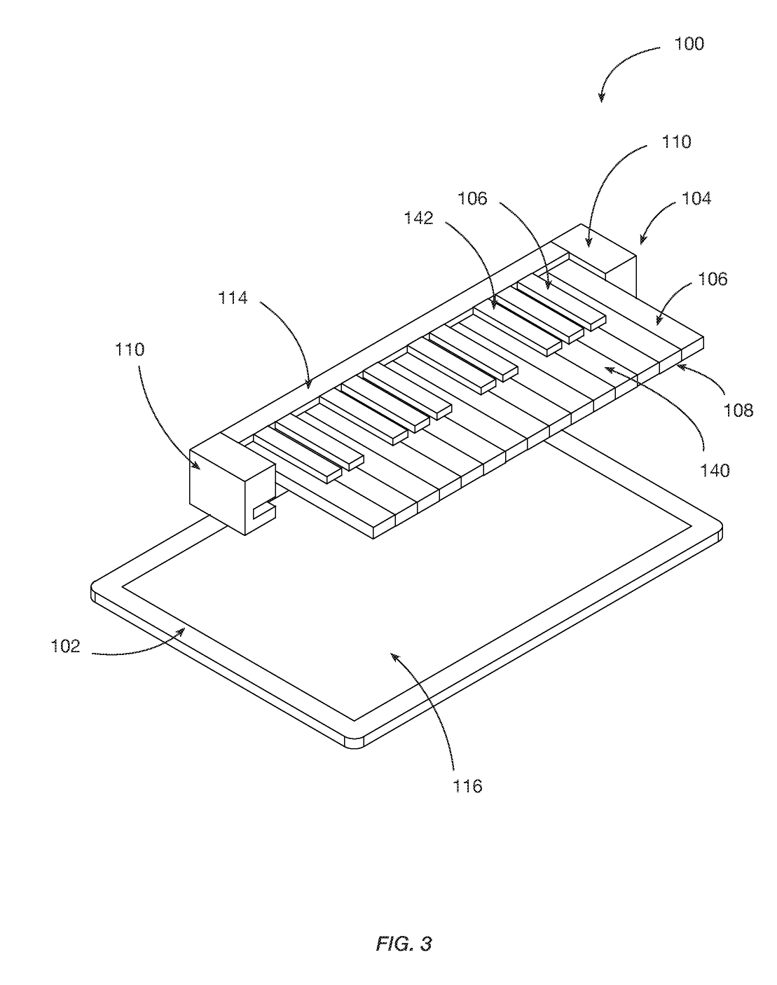

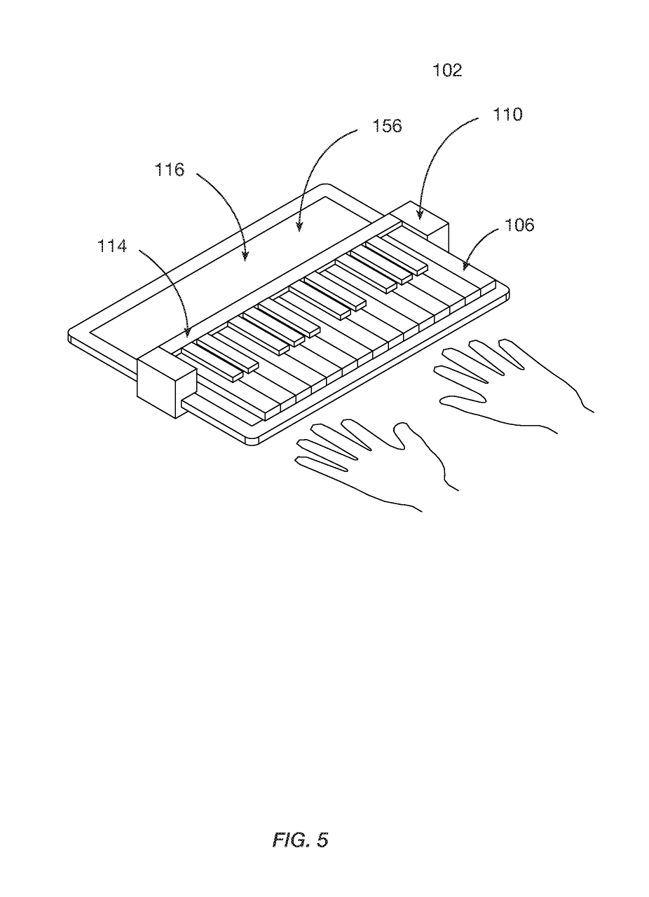

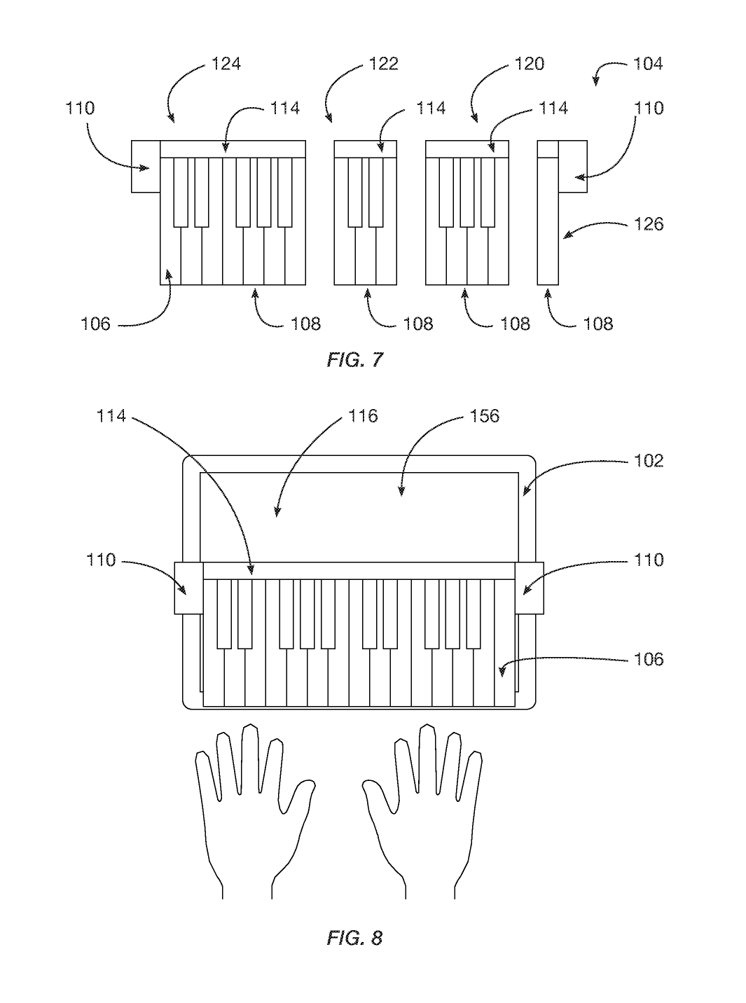

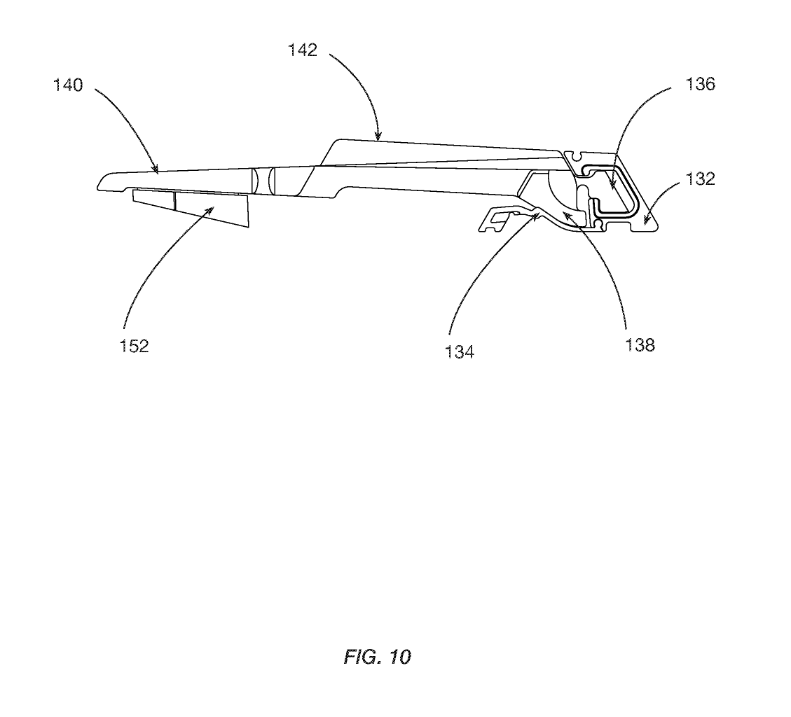

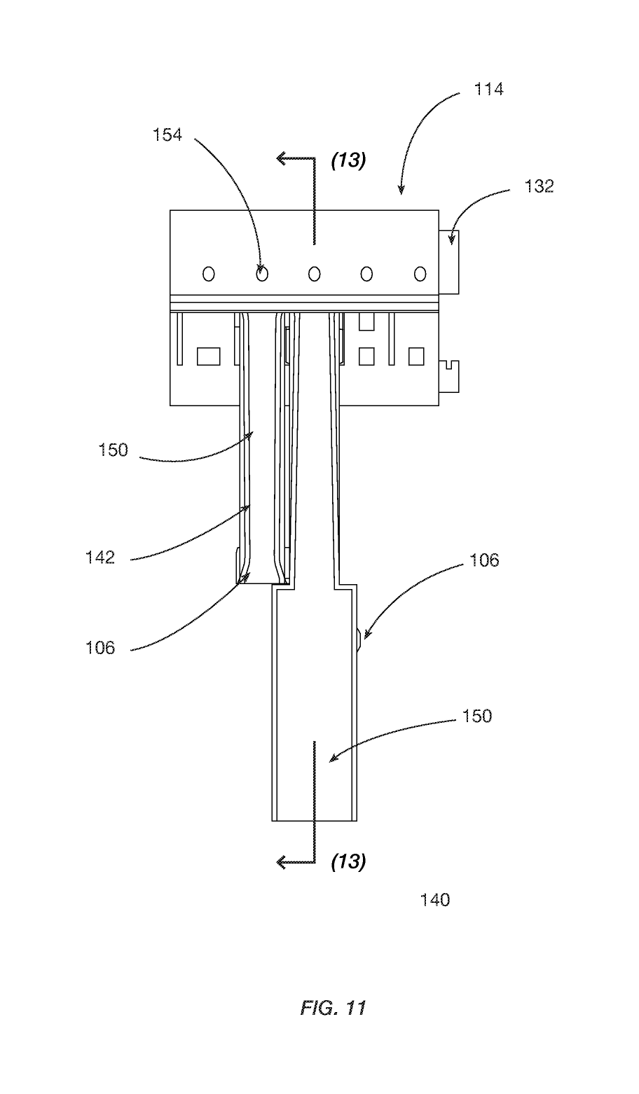

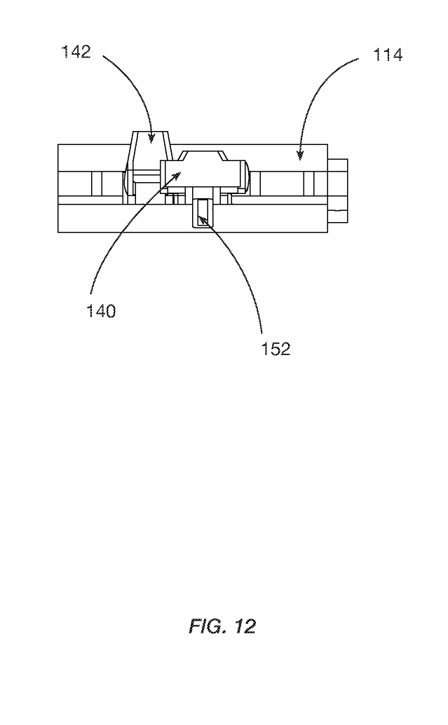

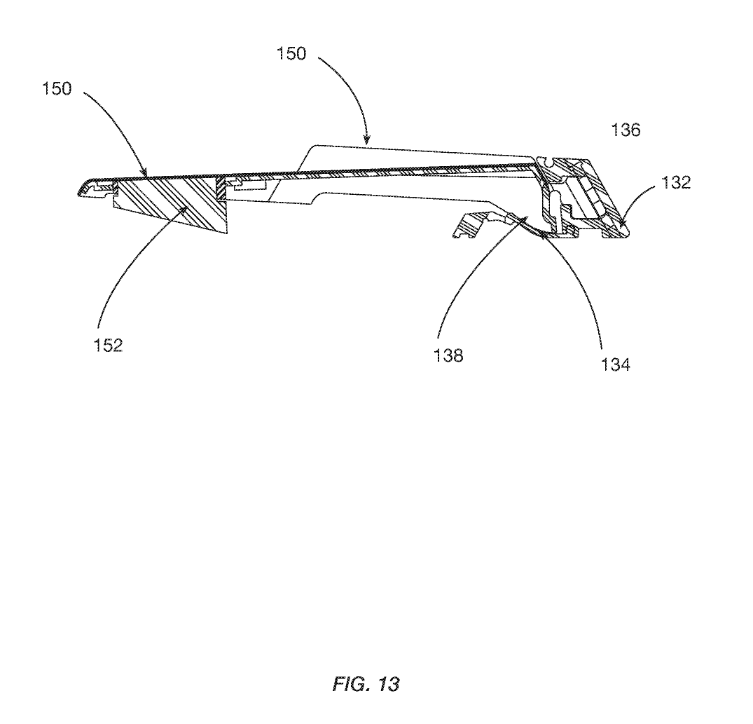

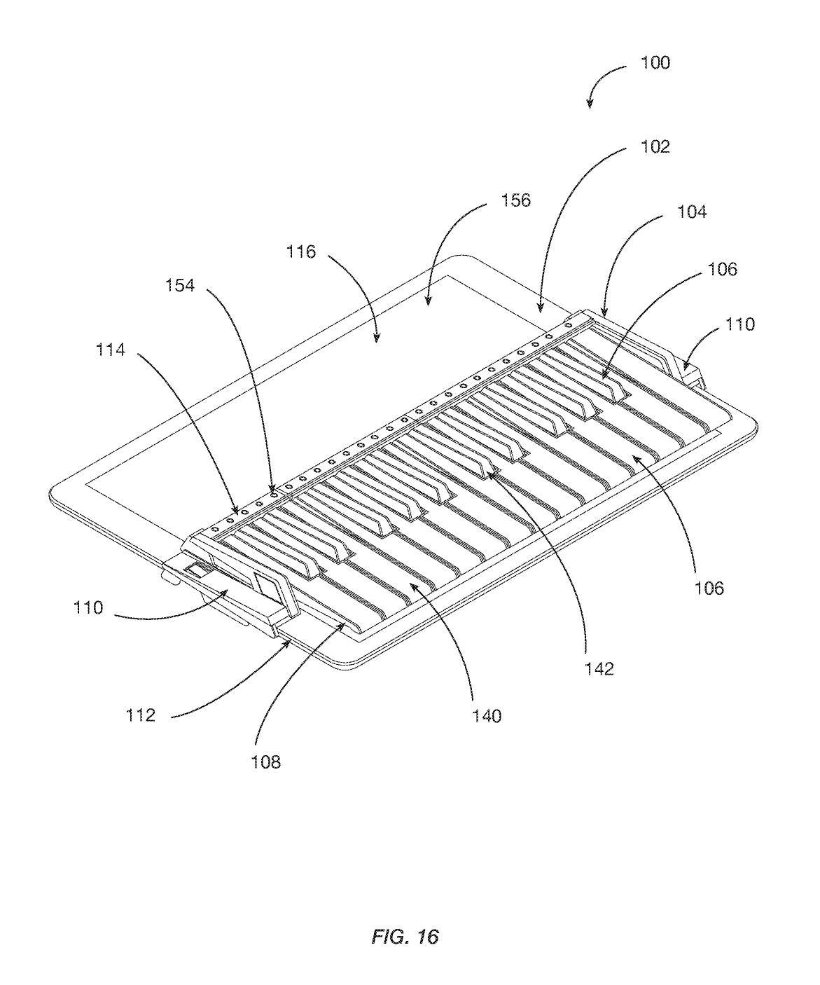

FIGS. 1-16 illustrate a haptic instrumental device 100 that includes an electronic device 102 in the form of a tablet and an assembled keyboard kit 104 having a plurality of keys 106 forming a keyboard 108. In some embodiments, the electronic device 102 may be provided in the form of a smart phone, tablet, or other devices having a screen with touch-screen capabilities. The touch screen of the electronic device 102 is designed to receive input by the user or control information processing through simple or multi-touch gestures by touching the screen. The touch screen allows a user to interact directly with the display as opposed to using an external device such as a keyboard, mouse, or the like.

The keyboard kit 104 also includes a plurality of mounting brackets 110 designed to grasp a periphery 112 of the keyboard 108. The keyboard kit 104 is designed for use as an attachment to the electronic device 102. In some embodiments, the keyboard kit 104 may be designed to be attached to a number of electronic devices having varying dimensions. Once assembled onto the electronic device 102, the keyboard kit 104 may emulate the physical properties of a traditional piano, allowing a user to receive haptic feedback from interaction with the plurality of keys 106. In some embodiments, and as will be discussed, the keyboard 108 may be created to provide a portable solution that may work in conjunction with a tablet or other electronic device of variable dimensions. In this illustrative embodiment, the keyboard kit 104 includes twenty-five keys 106, a plurality of mounting brackets 110, and a bracket connector 114.

Software may be installed on the electronic device 102 that is designed to be used in conjunction with the keyboard kit 104. For example, software in the form of an application or “app” may be provided on or downloadable to the device, and may be operable to receive input information from the one or more keys 106 indicative of a time and/or a velocity of one or more of the keys 106 being pressed or impacting a surface 116 of the device.

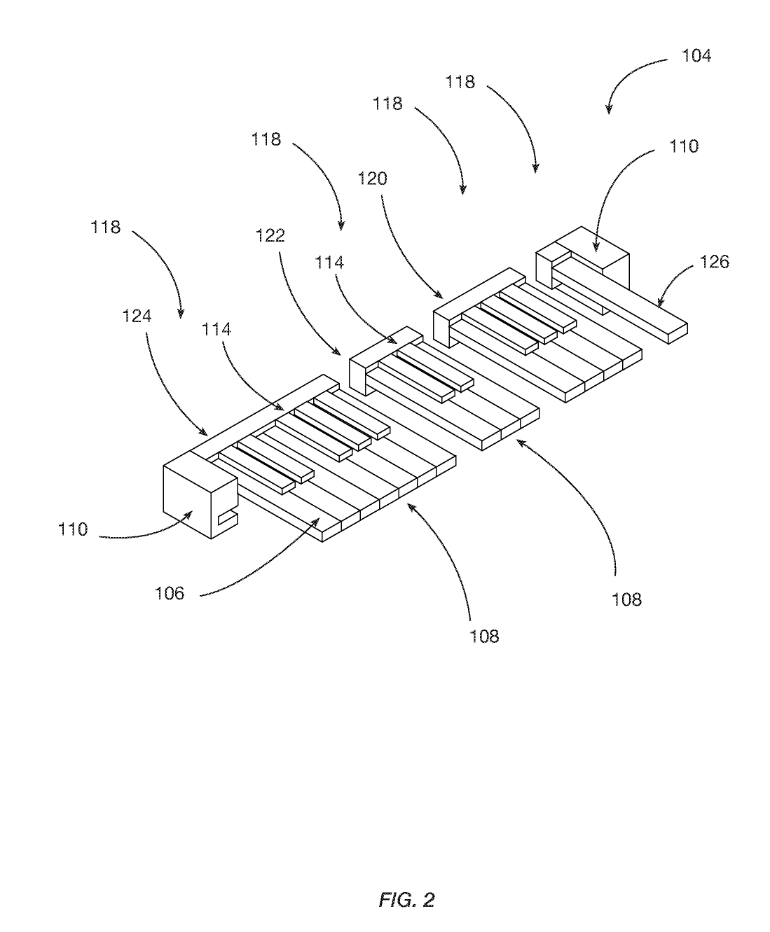

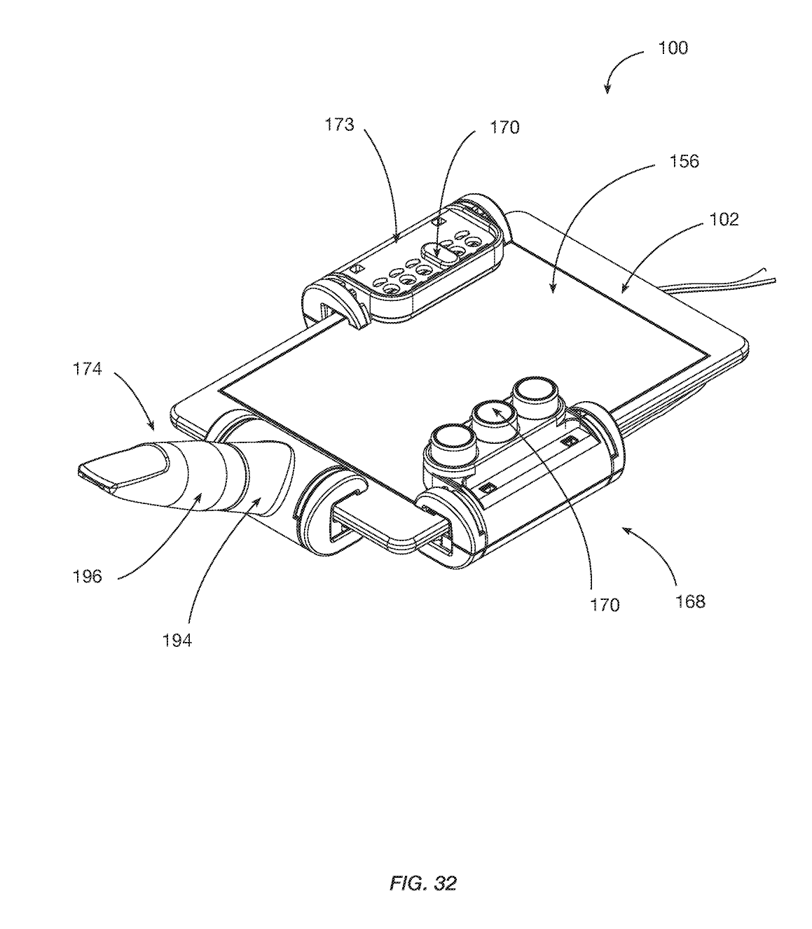

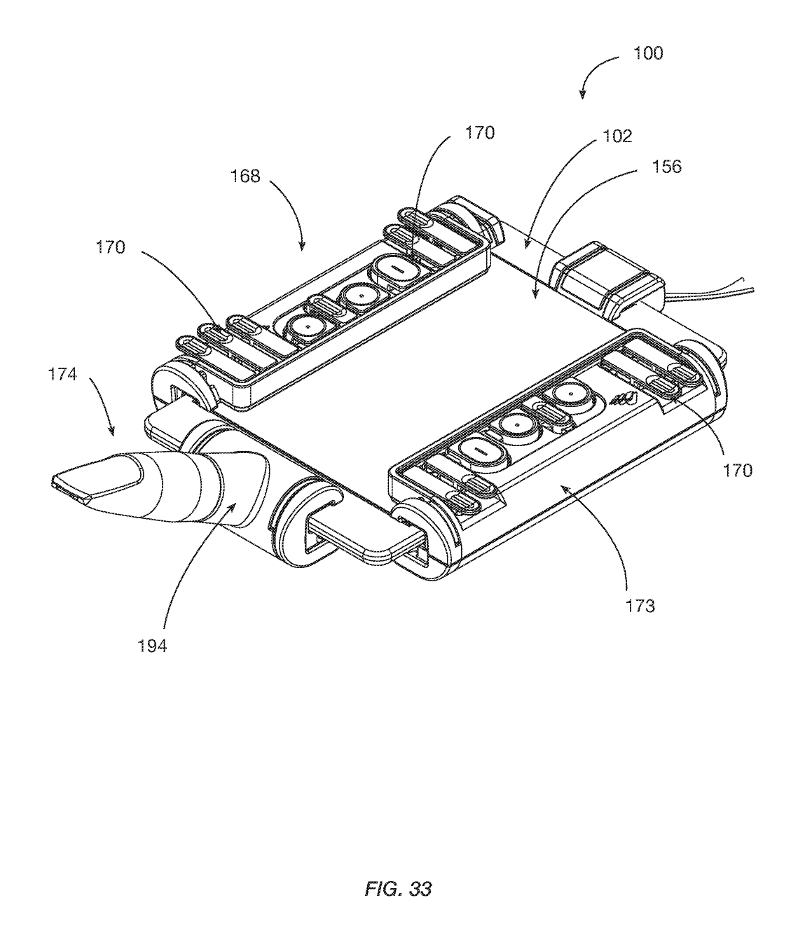

As shown in FIG. 2, the keyboard kit 104 may be provided as a plurality of units 118 (i.e., in a modular fashion). In this specific embodiment, the plurality of units 118 may include a plurality of internal key units 120, 122, a left outer key unit 124, and a right outer key unit 126. In this specific example, the internal key units 120, 122 are situated between the left outer key unit 124 and the right outer key unit 126. Each of the plurality of units 118 is designed to be connectable to and detachable from other units 118 (for example, to vary a width of the keyboard). During use, and in this specific example, the internal key units 120, 122 are connected to the left outer key unit 124 and the right outer key unit 126 to provide the keyboard kit 104. However, in this embodiment, the plurality of units 118 may be disconnected for ease of travel and/or storage. In some embodiments, and as depicted in the trumpet and reed wood instrument examples of FIGS. 32 and 33, the plurality of units 118 may not be modular, and may instead comprise a single piece.

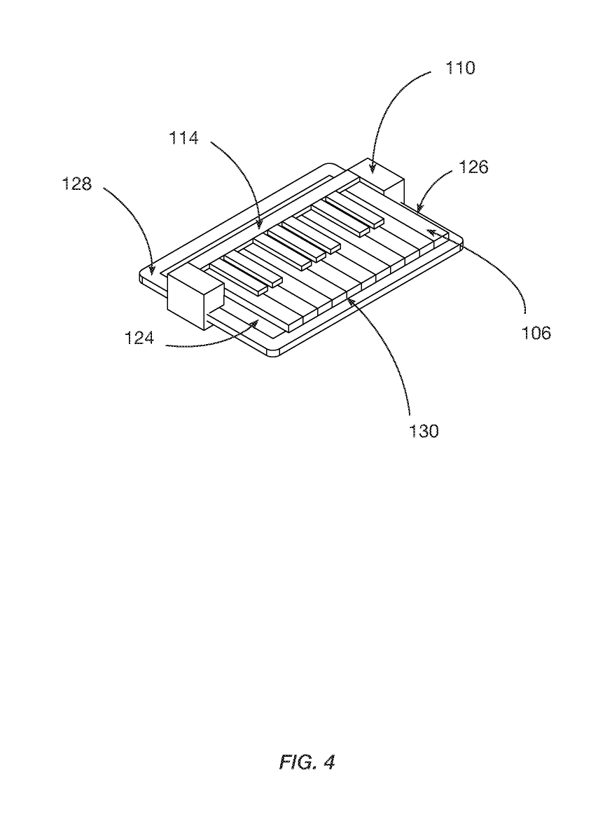

Further, it should be appreciated that additional units may be added to the keyboard kit 104 to provide a desired number of keys for the intended use. The number of keys provided by the plurality of units 118 may also be specific to the electronic device 102 to which the keyboard kit 104 is attached. For example, as shown in FIG. 4, a relatively small electronic device 128 may have a keyboard kit 104 that includes a single internal key unit 130, the left outer key unit 124, and the right outer key unit 126. Further, the plurality of units 118 may be provided in a variety of sizes with a varying number of keys 106. In an alternative embodiment, the keyboard kit 104 may be provided as one unit for simplicity and ease of use. In such an embodiment, the keyboard kit 104 may be provided in a variety of sizes. However, in this embodiment, the variety of sizes may be designed to fit the specific electronic device to which the keyboard kit 104 is applied.

As discussed above, when assembled, the keyboard kit 104 includes the keys 106, the plurality of mounting brackets 110, and the bracket connector 114. The mounting brackets 110 may be situated along the outer periphery 112 of the keyboard 108. As such, the mounting brackets 110 may provide a mechanism for attaching the keyboard kit 104 to the electronic device 102. In one embodiment, the mounting brackets 110 may have a snap engagement or elastic straps that engage with the electronic device 102. In an alternative embodiment, the mounting brackets 110 may slide in and out of the bracket connector 114 to increase or decrease a length of the keyboard kit 104 to a desired size to fit the electronic device to which the keyboard kit 104 is applied. In other illustrative embodiments, any suitable mounting mechanisms may be utilized including, for example, brackets, screws, releasable adhesive, and/or other mechanisms that allow the keyboard kit 104 to be releasably secured to the electronic device 102. In some specific embodiments, the mounting brackets 110 may include a mechanism to control the tightness of the interaction between the keyboard kit 104 and the electronic device 102.

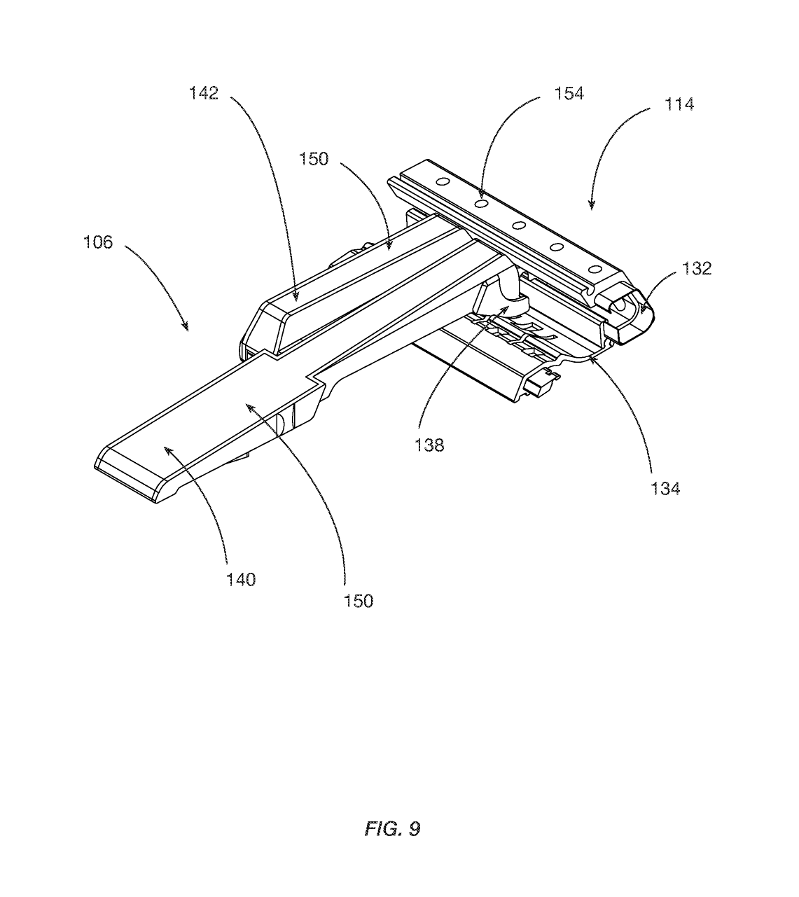

As shown in FIGS. 9-13, the keyboard kit 104 further includes the bracket connector 114. In this embodiment, the bracket connector 114 extends between the mounting brackets 110. Further, the bracket connector 114 may hold the keys 106 in place. The bracket connector 114 may include a C-shaped rod 132 with an outwardly extending flange 134. The bracket connector 114 may hold the keys 106 in place by fitting an engagement end 136 of the keys 106 within the C-shaped rod 132 of the bracket connector 114. The keys 106 may also include a curved portion 138 that has a complementary shape and fit with a curvature of the outwardly extending flange 134. In an exemplary embodiment, the outwardly extending flange 134 has a relatively flexible nature to allow the keys 106 to pivot when a user applies a downward force to the keys 106.

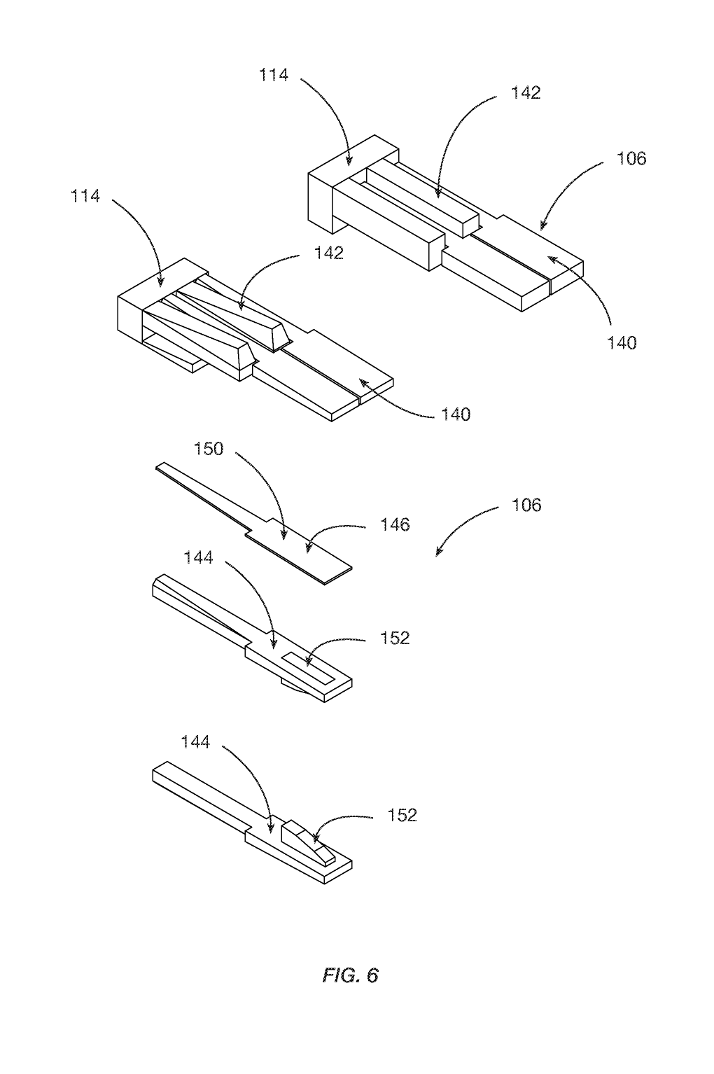

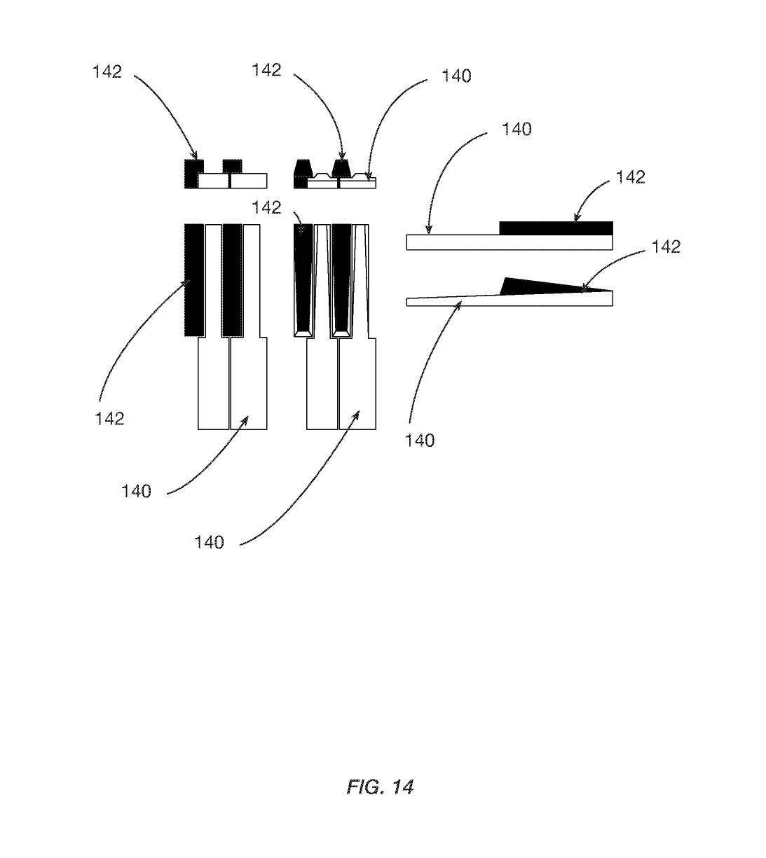

Referring to FIG. 14, a traditional square-shaped key 106 is shown adjacent an ergonomic key 106. Similar to a traditional piano, the keys 106 may include a plurality of white keys 140 and a plurality of half-step keys 142. In this example, and as shown in FIG. 6, the white keys 140 may have a body 144 and a top surface 146. Further, typical to traditional keys of a piano, the white keys 140 have a width that alters along the length thereof. As such, the half-step keys 142 fit intermittingly between the white keys 140. In addition, the half-step keys 142 may be flat, angled, or profiled. Illustratively, the half-step keys 142 may have a specific profile for a desired use thereof. Referring to FIG. 6, the top surface 146 of the white keys 142 may include one or more capacitive contacts 150. In the preferred embodiment, the capacitive contacts 150 may be in the form of an aluminum finish and/or a capacitive plastic on the top surface 146 of the keys 106. Further, the keys 106 may have a capacitive nib 152 that has a curved or angled profile. However, it should be understood that the capacitive nibs 152 may have a variety of shapes and sizes.

As previously mentioned, the keys 106 include one or more capacitive nibs 152 that are operable to interact with a surface 116 of the electronic device 102. Specifically, the keys 106 may have one or more capacitive nibs 152 provided along a bottom surface thereof. In addition or alternatively, the keys 106 may have a metal or capacitive plastic portion that conducts a charge to the capacitive screen when pressed. In a specific embodiment, the keys 106 have an aluminum finish or capacitive plastic on the top surface 146 thereof. On that basis, the keys 106 are capable of taking a charge from a body of a user and transferring the charge to the capacitive nibs 152.

The keys 106 may transfer the charge to the capacitive nibs 152 and, in effect, to the electronic device 102 to produce the desired sound. In this embodiment, the metal portion that conducts a charge to the capacitive screen is the capacitive contact 150. In the preferred embodiment, the white keys 106 and the half-step keys 106 include both the capacitive contacts 150 and the capacitive nibs 152. During use and as an illustrative example, the capacitive contacts 150 may act to transfer a conductive charge from the finger or thumb of a user to the respective capacitive nib 152 of the key 106 that is pressed and, by extension, transfer the charge to a capacitive screen of the electronic device 102.

In some embodiments, a feedback may also be provided when a user applies a pressure to the keys 106. For example, a “light” feedback indicator may be provided along or within the one or more keys 106. In this specific embodiment, a feedback indicator 154 is provided on the bracket connector 114. In some embodiments, a visual feedback indicative of whether one of the one or more keys 106 has been depressed is provided by the light of a display screen 156 of the electronic device 102. In some embodiments, light comes from the display screen 156 and through a clear plastic tube to illuminate the feedback indicator 154. Alternatively, the “light” may be programmed to provide an indication of which keys a user should press to conduct a variety of different musical exercises.

In particular, the capacitive nibs 152 act to input commands to the display screen 156 of the electronic device 102, which may be a mobile device or a graphics tablet. With such a display screen, a user may tap or depress one of the one or more keys 106, such that the one or more keys 106 lower to contact the surface 116 of the display screen 156. In particular, when the one or more keys 106 are depressed, the one or more nibs 152 contact the display screen 156. As a result, the one or more nibs 152 may be designed to provide information to the electronic device 102, such as how much pressure has been applied to the one or more keys 106. The one or more keys 106 may have one or more sensors provided therein that may further provide information to the electronic device 102. Electronic devices that operate and interface with a user through a change of inductance may allow for detection of varying degrees of pressure sensitivity, which allows for different sounds to be produced.

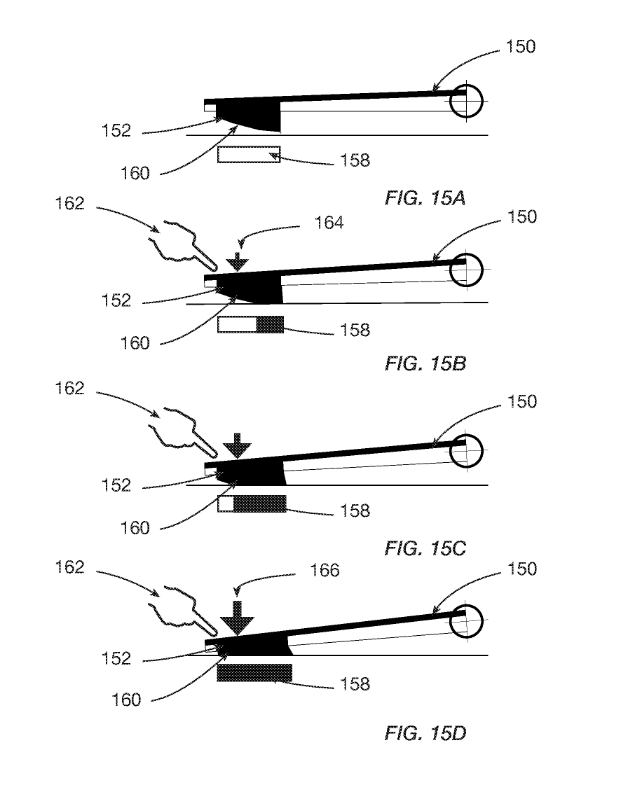

In some embodiments, the electronic device 102 may operate by the one or more capacitive nibs 152 inducing a vibration or by effectively connecting an electromagnetic circuit. Referring to FIGS. 15A-15D, a plurality of physical inputs, indicative of a pressure applied to the keys 106, are illustrated. Further, in this example, a duration or length of time the pressure is maintained to the one or more keys 106 may be measured by the electronic device 102. In some embodiments, a speed of impact may also be measured. In addition, a velocity or a magnitude of a force applied thereto may be measured. For example, a time required for the key to move from a starting position to a position that contacts the display screen 156 may be measured. As a result, this time may be used to determine a relative velocity of the key upon application of a force applied by a user.

Further, the electronic device 102 or program installed thereon, may be capable of measuring a contact area 158 between the capacitive nibs 152 and the display screen 156. As mentioned, contact area 158 may be defined as the area of contact between the capacitive nib 152 and the display screen 156 of the electronic device 102. Further, a duration of time in which the key 106 is pressed may be measured by the keyboard kit 104 and/or the electronic device 102. As a result of the aforementioned measurements, input data may be received by the electronic device 102 from each key 106. The key strokes and input data may be processed by the software. Once processed by the software, the input data is used to determine the resultant sound and/or note produced by the electronic device 102.

In this specific embodiment, the capacitive nibs 152 have a bottom surface 160 that is curved or angled. As such, only a portion of the bottom surface 160 may contact the display screen 156 of the electronic device 102 to provide the contact area 158. As shown in FIGS. 15A-15D, the portion or contact area 158 contacted by the capacitive nib 152 may be dependent on a force 162 applied to the key 106. For example, a small force 164 may be applied to the key 106 to result in only a portion of the nib 152 to contact the display screen 156. On the other hand, a large force 166 may be applied to the key 106 to result in the entirety of the bottom surface 160 of the nibs 152 to contact the display screen 156. As such, the contact area 158 may be dependent upon the relative force applied to the keys 106.

As a result of the relative force applied to the keys 106, the aforementioned software installed on the electronic device 102 may be used to measure the contact area 158 and produce a sound relative to a magnitude of the force 162 applied to the key 106. In a specific embodiment, the one or more keys 106 are depressed to produce the contact area 158 and during the key press, the software may continuously monitor (e.g., at 10 ms resolution) a change in the contact area 158. The capacitive nibs 152 may also be calibrated to emulate the stroke of a hammer of a string in a traditional piano. In other words, the capacitive nibs 152 may be calibrated so that a force applied to a traditional piano key to produce a desired sound or note on the traditional piano may produce the same sound or note when the same force is applied to the keys 106.

Based upon one or more of which of the keys 106 are pressed down, the length of time the one or more keys 106 are pressed, the contact area 158 on the display screen, a change in the contact area 158 over a time, the velocity of the press, and/or other variable measured by the keyboard kit 104, a sound may be outputted from one or more speakers either within the electronic device 102 or from an external sound source. For example, what is referred to as a “note envelope” may be sent to the one or more speakers with corresponding characteristics of one or more of an attack time, a sustain time, and/or a decay time. Dependent upon how the one or more keys 106 are depressed, the software may produce a sound for the appropriate instrument selected with a specific loudness, sustain duration, decay time, etc. In some embodiments, the software is programmed to await additional instructions for a new input, thereby reverting to receive a new input after outputting a sound for a pressed key or combination of keys. In some embodiments, additional features may be included in the software such as the ability for a user to calibrate key sensitivity, in order to play displayed notes and chords. Further, the software may be capable of receiving and processing combinations of keys pressed in order to play a specific note.

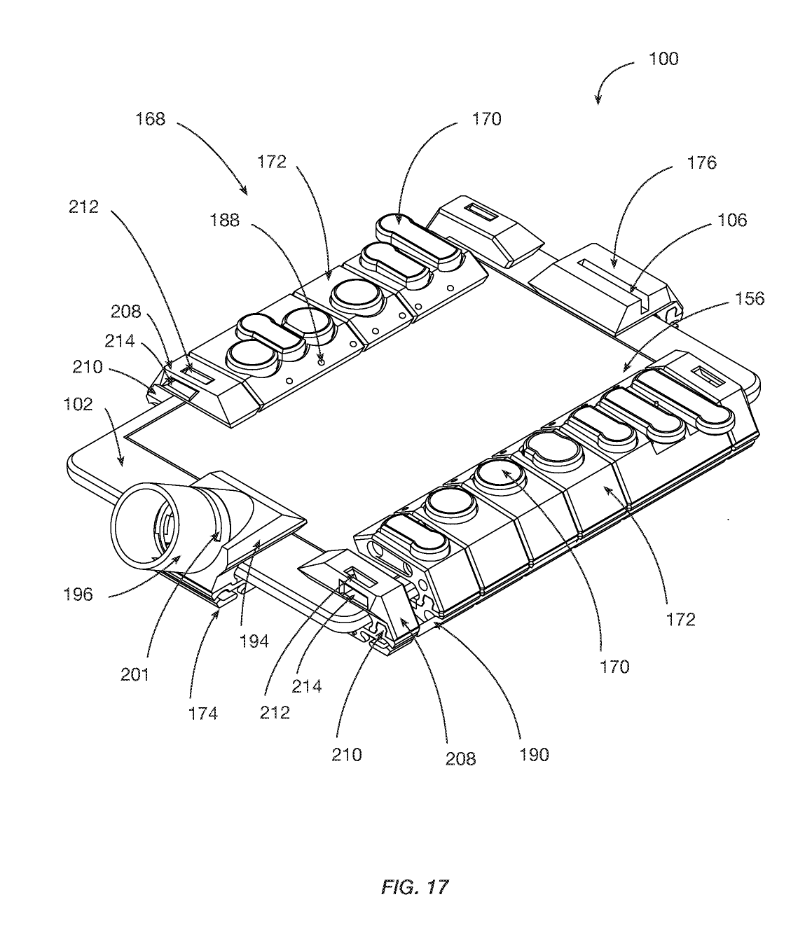

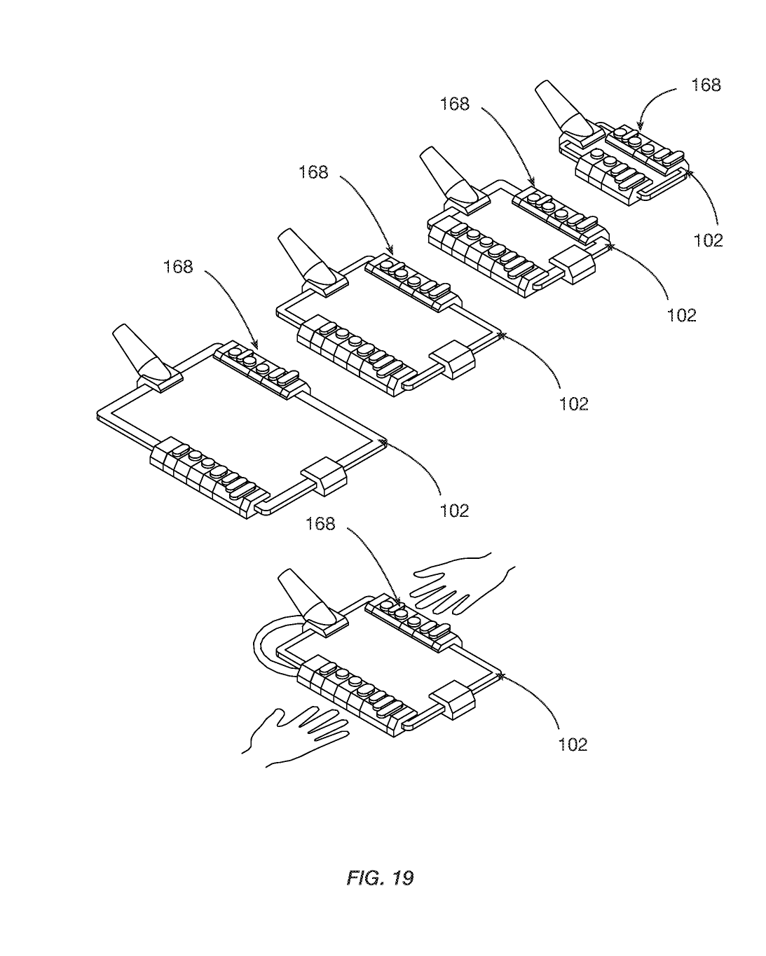

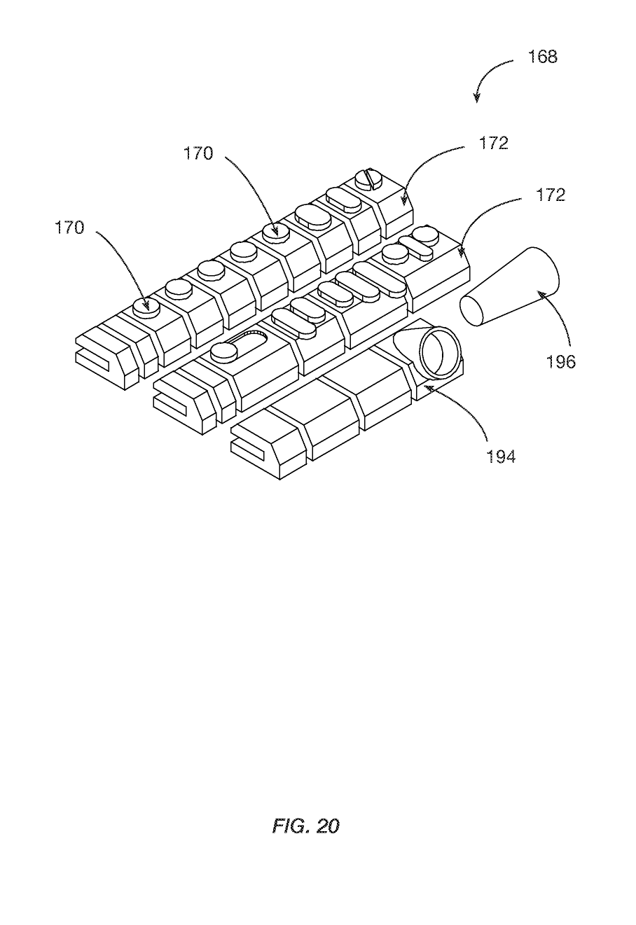

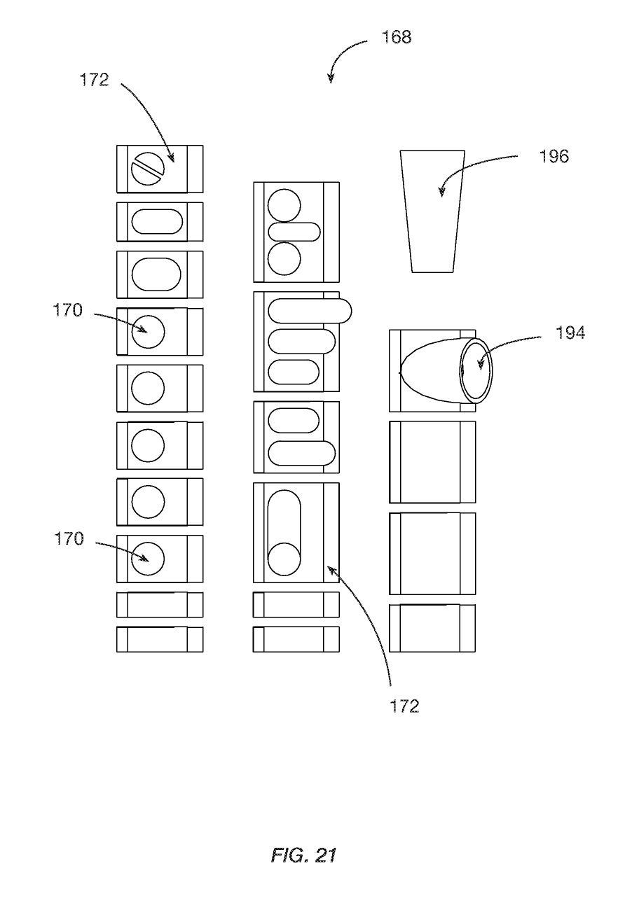

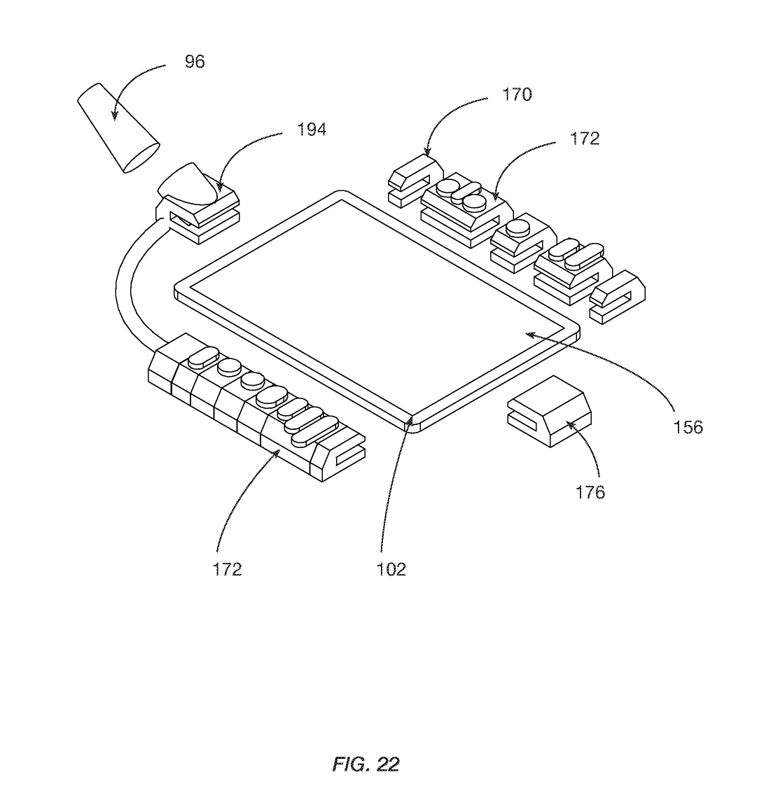

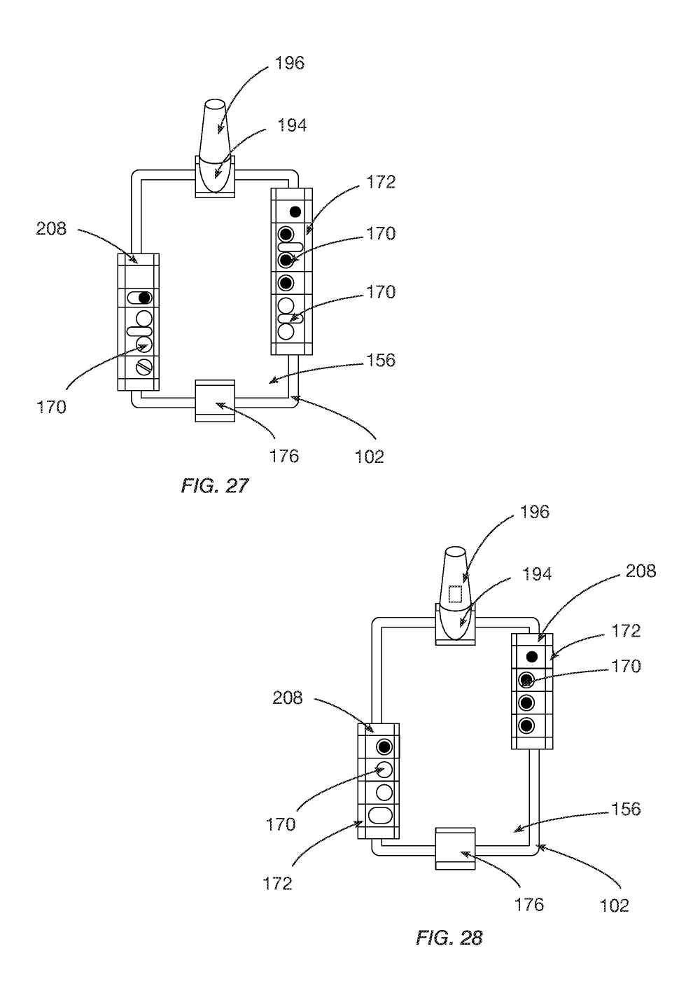

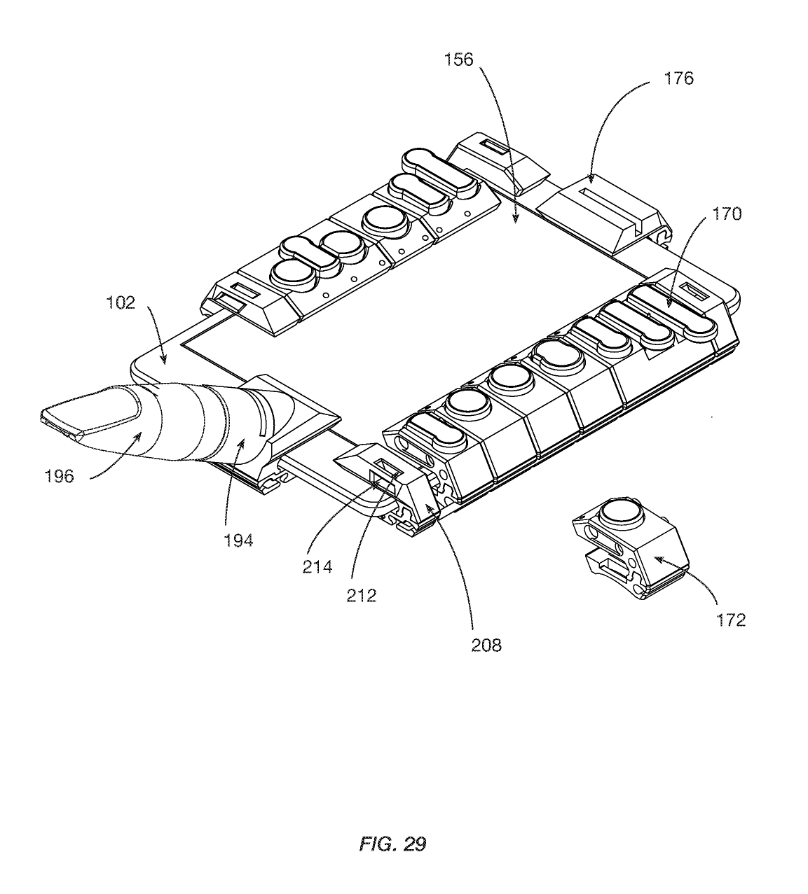

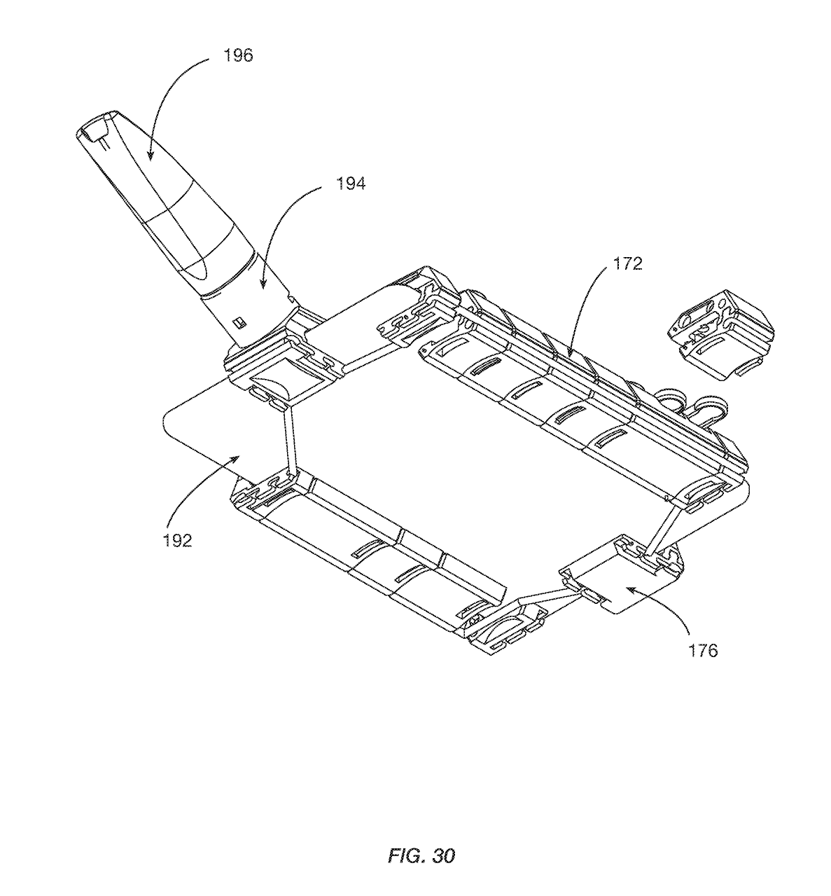

Referring now to FIGS. 17-33, another form of the instrumental device 100 is shown in additional embodiments. As illustrated in the figures, the instrumental device 100 may be used to mimic a wind instrument or another type of instrument that requires the use of a mouthpiece. A wind instrument kit 168 may be designed to work with the electronic device 102. The wind instrument kit 168 allows for the reconfiguring of one or more buttons 170 to play a variety of wind instruments. The wind instrument kit 168 allows an operator to have a portable alternative to existing wind instruments that works in conjunction with the electronic device 102, such as a tablet computer or other mobile device. The wind instrument kit 168 may include a set of interlocking modules 172 or may be made of a single element 173 (see FIGS. 32-33) having multiple keys, as discussed hereinafter below. The one or more modules 172 serve as individual keys on a wind instrument. The wind instrument kit 168 may also include a mouthpiece assembly 174. Further, the wind instrument kit 168 may include a strap bracket 176. In a similar manner as that described above with regard to the keyboard kit 104, a capacitive button 178 may be included within each module 172 to interact with the display screen 156 of the electronic device 102.

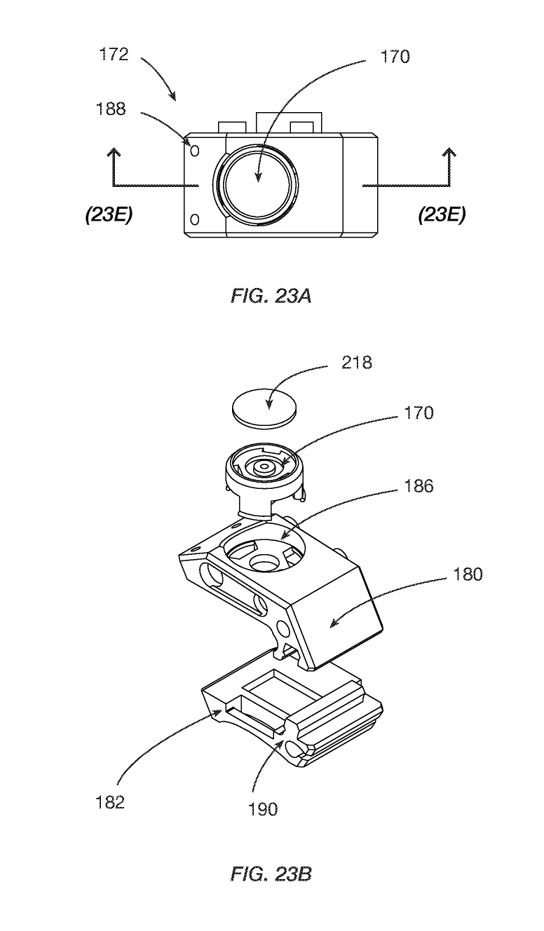

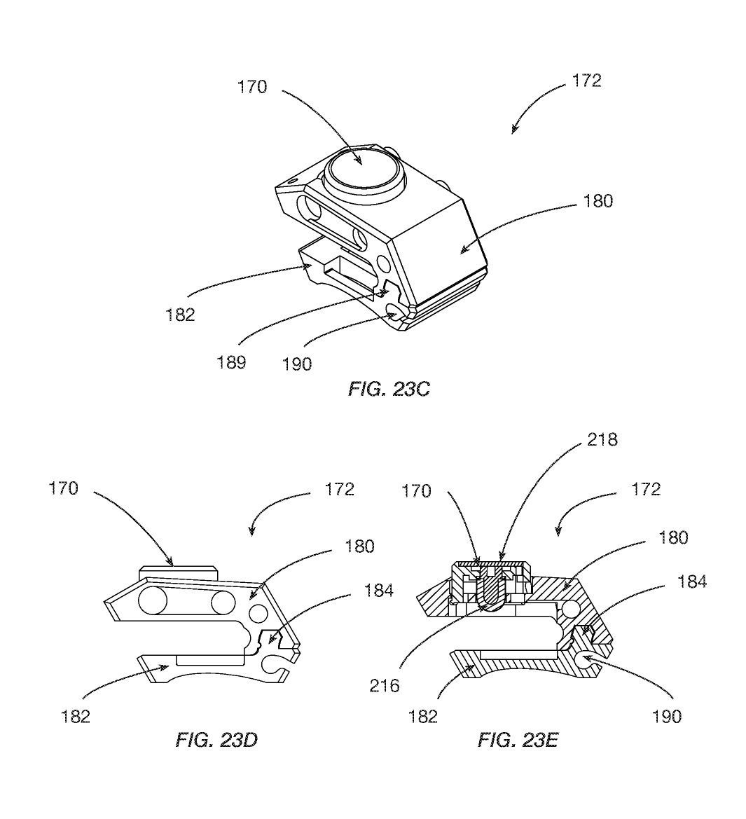

Referring to FIGS. 23A-23E, the one or more modules 172 may have a top part 180 and a bottom part 182 which are connected by a hinge 184. To that end, the one or more modules 172 may have an adjustable thickness as a result of the hinge 184. In addition, the hinge 184 allows the modules 172 to be attached to and detached from the electronic device 102 with ease. Further, the modules 172 may have a variety of shapes and sizes. As is known in the art, musical instruments may have a variety of key sizes and shapes. Therefore, it should be understood that the modules 172 may be provided in a variety of shapes and sizes, and are not so limited to a specific shape and/or size. In some examples, the buttons 170 may be arranged to be indicative of a key arrangement corresponding to one or more of the following wind instruments: accordion, air horn, bagpipe, bassoon, clarinet, flute, French horn, oboe, ocarina, pan flute, piccolo, trumpet, trombone, tuba, or any other wind instrument.

As mentioned, the modules 172 may include the top part 180. Specifically, the top part 180 may include a cavity 186 and a button 170 that may be inserted therein. In addition, the top part 180 may include a feedback indicator 188 provided along each of the modules 172. Similar to the keyboard kit 104, and referring to FIG. 23A, the feedback indicator 188 may provide a feedback when a user applies a pressure to the button 170. For example, a “light” feedback indicator may be provided along or within the button 170. In some embodiments, the feedback indicator 188, which can indicate whether one of the one or more buttons 170 has been depressed, may also be provided through the display screen 156 of the electronic device 102, as previously discussed. In some embodiments, the feedback light comes from the display screen 156 through a clear plastic tube or via another light transportation mechanism such as a light pipe. Alternatively, the instrumental device 100 may be programmed to provide an indication of which buttons a user should press to conduct a variety of different musical exercises.

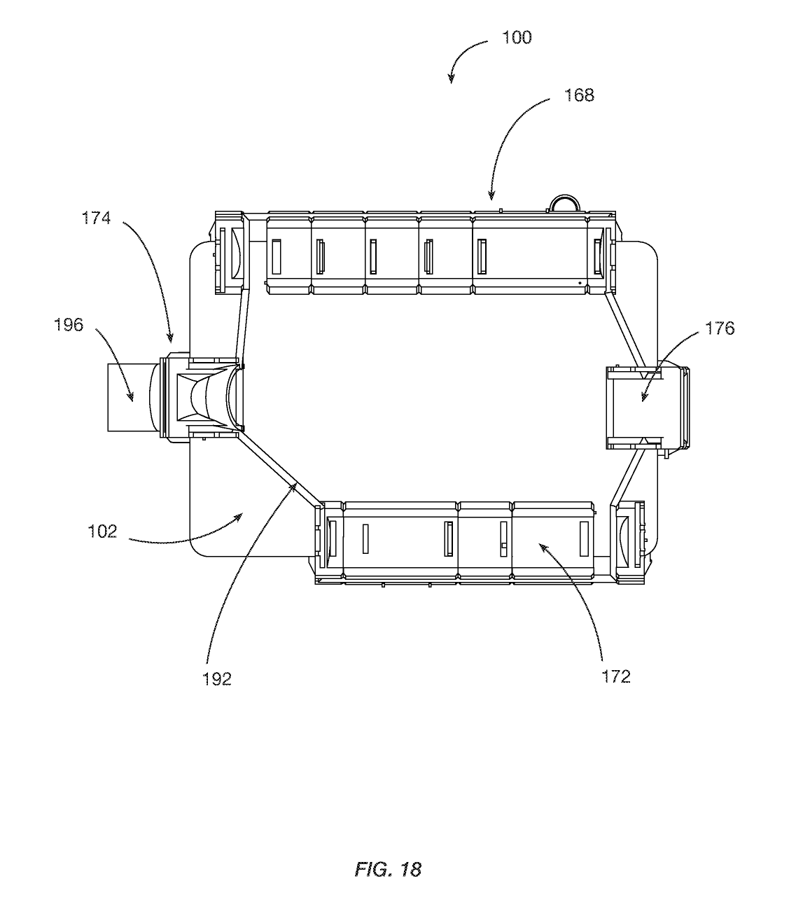

The modules 172, the mouthpiece assembly 174, and the strap bracket 176 may also have a slot 190. As shown in FIG. 18, an elastic strap 192 may be inserted in each of the slots 190 of the modules 172, the mouthpiece assembly 174, and the strap bracket 176 to hold the pieces in place once they have been attached to the electronic device 102.

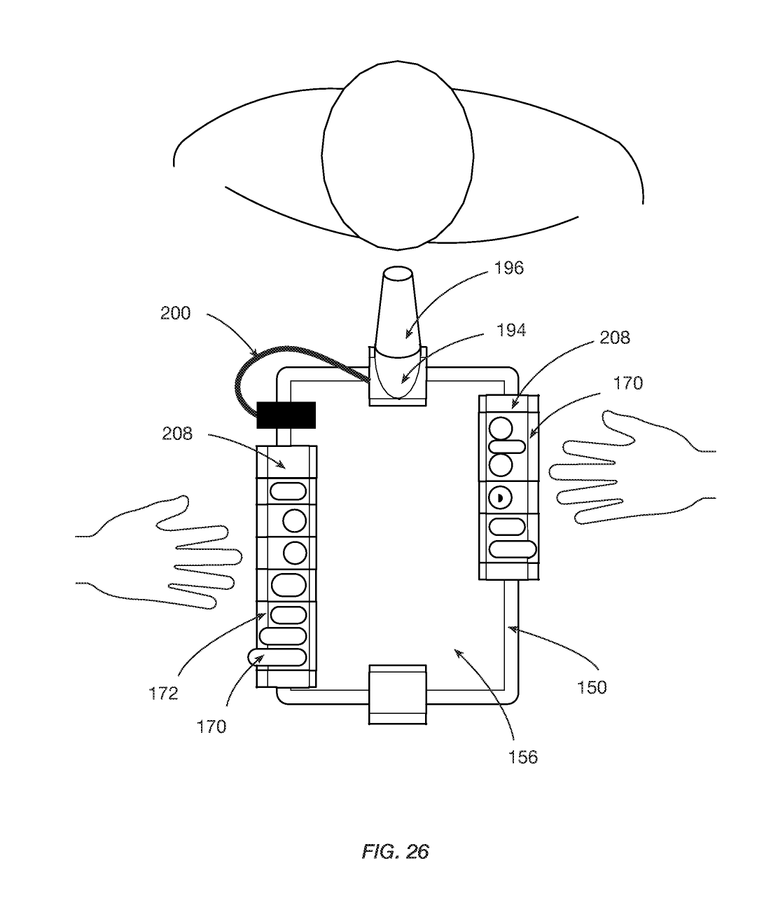

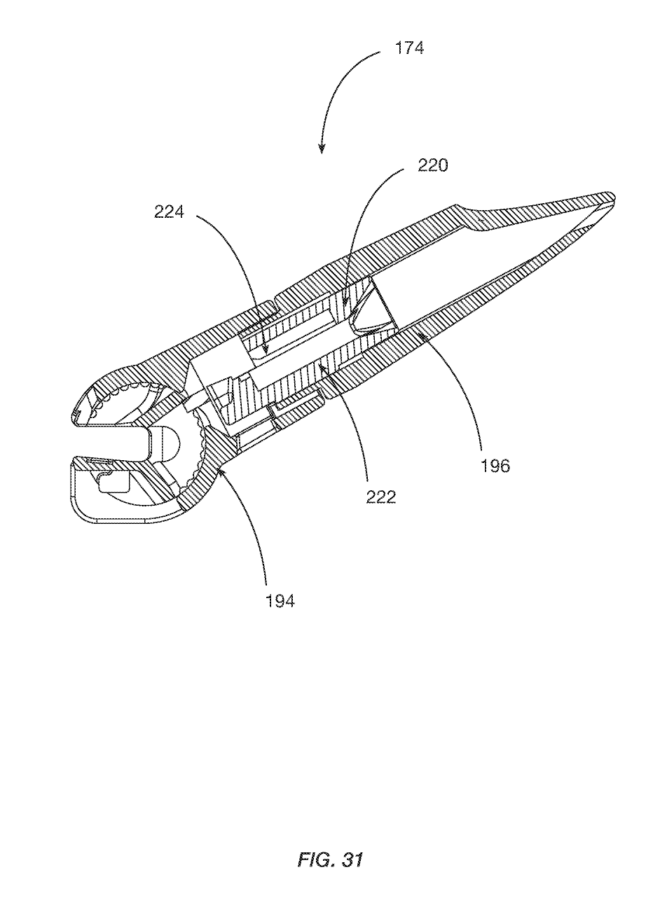

The mouthpiece assembly 174 may include a mouthpiece holder 194 and a mouthpiece 196 attached thereto. The mouthpiece holder 194 may also operate with a hinge to allow for attachment to and detachment from the electronic device 102. In the preferred embodiment, the mouthpiece assembly 174 is placed relative to a microphone of the electronic device 102. As such, a user may blow into the mouthpiece 196 at a certain decibel and/or pitch that may be measured by the microphone of the electronic device 102. For non-brass instruments, a constant pitch is created by a built-in reed (see FIG. 31) inside of the mouthpiece 196. Alternatively, the mouthpiece assembly 174 may be connected to an electronic convertor assembly 200 (see FIG. 26), which could be implemented by electronic components.

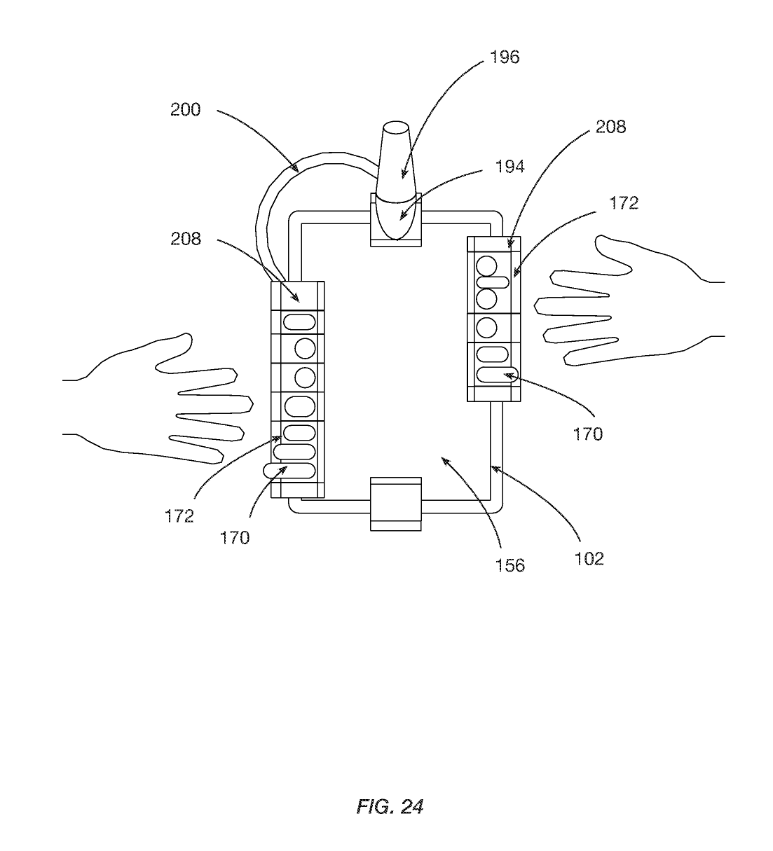

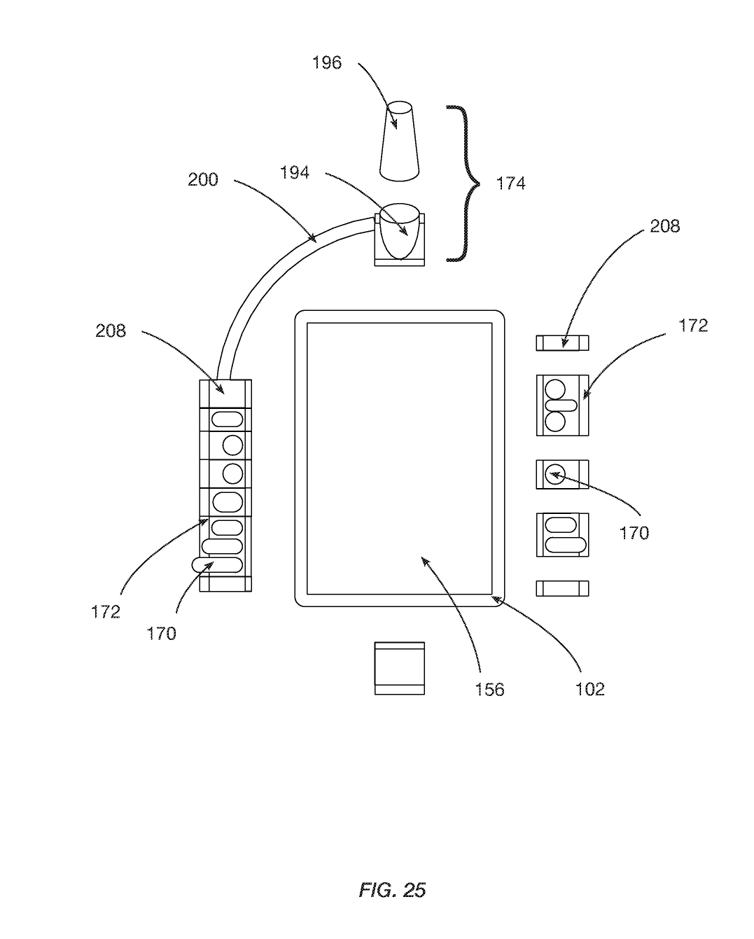

In some embodiments, the converter assembly 200 is a tube through which air/sound/volume/pitch travel from the mouthpiece 196 to a microphone in the electronic device 102. In this specific example, the mouthpiece assembly 174 is capable of sending information to the electronic device 102 using similar capacitive technology as that of the modules 172. In yet another alternative embodiment, the mouthpiece assembly 174 may be connected to one or more of the modules 172 and may send input information through the modules 172 to the electronic device 102 (see FIGS. 24-25). The decibel and/or pitch may be measured by the microphone of the electronic device 102 to produce an output sound. The mouthpiece assembly 174 may also include a moisture filter slot 201 and a moisture drain 202 to allow moisture, e.g., saliva or undesired vapor, to drain therefrom.

In still another embodiment, a sensor (not shown) within the mouthpiece receives signals indicative of decibel level, pitch, etc. The sensor may be connected to a controller that can be located within the mouthpiece 196 or can be provided at another location. The sensor may be operative to receive a signal indicative of a pressure. Thus, the sensor may be a pressure sensor. Another sensor may be provided within or along the mouthpiece 196 and may be capable of receiving information indicative of a force or pressure applied by the lip or mouth of a user. Such a sensor may be helpful to emulate a desired pitch input.

The wind instrument kit 168 may also include the strap bracket 176. The strap bracket 176 operates with a hinge 204 to attach and detach from the electronic device 102. In addition, the strap bracket 176 also includes a slot 206. In some embodiments, a strap (not shown) may be inserted into the slot 206. In this example, a user may place the strap around their neck or along their shoulder. Alternatively, a mirror (not shown) may be inserted into the slot 206. In another embodiment, the slot 206 may be used to place a musical note sheet therein.

Referring again to FIG. 17, the wind instrument kit 168 may further include a plurality of arm strap connections 208. The arm strap connections 208 may define a hinge 210 that can allow the arm strap connections to attach to and detach from the electronic device 102. In this embodiment, the arm strap connections 208 have a first aperture 212 on a top side thereof and a second aperture 214 on a side thereof. Therefore, the arm strap connections 208 may be attached to a plurality of straps (not shown) by inserting a strap through the first aperture 212 and out of the second aperture 214. During use, a user may insert their arms into the plurality of straps. As a result, the wind instrument kit 168 and the electronic device 102 may rest upon a user's shoulders to allow the user to play the wind instrument kit 168 with ease.

Software installed on the electronic device 102, possibly in the form of an application or an “app” runs or activates the modules 172 of the music instrument. Haptic or kinesthetic communication between the wind instrumental kit 168 and a user recreates the sense of touch by applying forces, vibrations, or motions to the user. Haptic devices may also incorporate tactile sensors that measure forces exerted by the user on the interface. Similar to the keyboard kit 104, the modules 172 may include a plurality of capacitive nibs 216 and a conductive contact 218. The conductive contacts 218 and the capacitive nibs 216 act similarly to the keys 106 to input commands to the display screen 156 of the electronic device 102. With such a display screen, a user taps one of the one or more buttons 170 such that the one or more buttons 170 are pressed down toward the surface 116 of the display screen 156 to cause the one or more nibs 216 to tap or touch the display screen 156. The one or more nibs 216 may be designed to provide information to the electronic device 102, such as how much pressure has been applied to the one or more buttons 170 or another type of information.

The one or more modules 172 may have one or more sensors provided therein that further provide information to the electronic device 102. Electronic devices that operate and interface with a user through a change of inductance may allow for detection of varying degrees of pressure sensitivity, which allows for different sounds to be produced. In some embodiments, the wind instrument kit 168 operates by receiving a signal via the one or more conductive contacts 218, which can be made from metal or conductive plastic, and via the one or more capacitive nibs 216 inducing a vibration or by effectively connecting an electromagnetic or other circuit (formed by the kit 168) with the electronic device 102. The wind instrument kit 168 is capable of taking similar measurements to those discussed in connection with the keyboard kit 104. Further, the modules 172, and more particularly the buttons 170, may also be capable of measuring vibrations provided on the buttons 170. Such vibrations on a traditional key of a wind instrument produces alternatives in the pitch or sound of a note, e.g., a vibrato.

As a result of such measurements, input data may be received by the electronic device 102 from each module 172. The input data may be processed by the software. In some embodiments, the modules 172 may also be calibrated to emulate the sensitivity of the keys of the specific instrument the wind instrument is mimicking. In other words, the modules 172 may be calibrated to have a relative sensitivity, or the like, of a traditional key of a saxophone, trumpet, etc. As a result, the modules 172 may provide the sensation of playing a traditional wind instrument. Further, the capacitive nibs 216 may also be calibrated. In the preferred embodiment, the capacitive nibs 216 may be calibrated to emulate sensitivity of a key on the respective key of the wind instrument the wind instrument is imitating. Simply put, the modules 172 may be calibrated so that a force, or an alteration in forces applied to a traditional wind instrument, may produce the same sound or note when the same force is applied to the modules 172, or more particularly, to the buttons 170.

In some embodiments, the wind instrument kit 168 may be customizable so that a user may reconfigure the modules 172 to simulate a variety of different wind instruments. Thus, users are not limited to a single button configuration, as is typically the case for most wind instruments and electronic wind instruments. A physical input may be received by the one or more modules 172 and may be transferred to the electronic device 102 when the one or more buttons 170 are depressed. The one or more buttons 170 may be depressed for a first amount of time. Further, the mouthpiece may be blown into by a user and input data received from each of the buttons and the mouthpiece may be processed by the software. The duration or length of time that the one or more buttons 170 are pressed, or a combination of the buttons 170 being pressed, may produce a note corresponding to a traditional wind instrument. Further, a decibel level, a pitch, and/or a plurality of fluctuations may be logged by the software using the microphone and/or the display screen 156 of the electronic device. As a result, an output sound or note may be determined by the software using the received input data.

An output sound from one or more speakers may be determined based upon a note envelope that is sent to the speaker with corresponding characteristics. The note envelope is dependent upon the one or more buttons pressed, a dB level, a pitch that is logged, or other variable measured by the modules 172 and/or the electronic device 102. The software produces a sound that is appropriate for the selected instrument, with a specific loudness, sustain duration, etc. In the preferred embodiment, the software is constantly waiting for new input data to loop back.

Referring to FIG. 31, a cross-sectional view of an embodiment of the mouthpiece assembly 174 is shown. The mouthpiece assembly 174 may be for a wind instrument, and can allow for a constant pitch to be created by a built in reed (not shown) inside of the mouthpiece assembly 174. As shown in FIG. 31, a reed holder 220 is shown having a first portion 222 and a second portion 224. The first portion 222 and the second portion 224 are offset from one another and are opposing each other within the mouthpiece 196. The first portion 222 and the second portion 224 may be formed to hold a reed that can be installed within the mouthpiece assembly 174. The reed holder 220 may be disposed in a configuration as shown in FIG. 31, or may be formed in another configuration as known to those skilled in the art.

Referring to FIGS. 32 and 33 the wind instrument kit 168 is shown with the single element 173 having multiple keys. FIG. 32 depicts a button configuration for a trumpet, while FIG. 33 depicts a button configuration for a reed wood instrument. The embodiments depicted in FIGS. 32 and 33 may have substantially the same features as the embodiments discussed above, with the difference being that instead of one or more sets of interlocking modules 172, attached to each side of the electronic device 102, the single element 173 having a plurality of buttons 170 is provided.

It will be appreciated by those skilled in the art that while the invention has been described above in connection with particular embodiments and examples, the invention is not so limited, and that numerous other embodiments, examples, uses, modifications, and departures from the embodiments, examples and uses are intended to be encompassed by the claims attached hereto. Various features and advantages of the invention are set forth in the following claims.

1. A haptic instrumental device comprising:
one or more modules comprising one or more buttons, the one or more modules configured to be attached to an electronic device; and
one or more brackets coupled with the one or more modules and secured to the electronic device,
wherein the one or more modules include one or more capacitive nibs that are configured to contact a display screen of the electronic device to cause the electronic device to receive an input after at least one of the one or more buttons is depressed.

2. The haptic instrument device of claim 1, wherein at least one variable is measured by the electronic device utilizing a change in a capacitive conductance.

3. The haptic instrument device of claim 2, wherein the at least one variable may comprise at least one of a velocity of depression of the one or more buttons, a pressure applied to the electronic device, a contact area of a display screen of the electronic device touched by the one or more capacitive nibs, and a duration that the one or more capacitive nibs contact the display screen.

4. The haptic instrument device of claim 1, wherein the one of more buttons provide a capacitive conductance to the electronic device.

5. The haptic instrument device of claim 1, wherein the one or more capacitive nibs include one of aluminum and a capacitive plastic.

6. The haptic instrument device of claim 1 further comprising a mouthpiece assembly secured to the electronic device.

7. The haptic instrument device of claim 1 further comprising a strap bracket secured to the electronic device, wherein the strap bracket includes a slot that is operable to receive an object.

8. The haptic instrument device of claim 1, wherein the plurality of buttons are configured in the form of a set of piano keys.

9. A haptic instrumental device comprising:
one or more keys and a mouthpiece assembly configured to be attached to an electronic device; and
one or more brackets coupled with the one or more keys and the mouthpiece assembly and secured to the electronic device,
wherein the one or more keys include one or more capacitive nibs that are configured to contact a display screen of the electronic device to cause the electronic device to receive an input, and
wherein an electronic device to which the haptic instrumental device is attached receives input through a microphone of the electronic device that receives an input through the mouthpiece assembly.

10. The haptic instrumental device of claim 9, wherein the mouthpiece assembly includes a mouthpiece holder and a mouthpiece.

11. The haptic instrumental device of claim 10 further comprising a reed holder disposed within the mouthpiece.

12. The haptic instrumental device of claim 11, wherein the reed holder includes a first portion and a second portion, the first portion disposed opposing the second portion.

13. The haptic instrumental device of claim 9, wherein at least one of the one or more capacitive nibs comprise a capacitive plastic.

14. The haptic instrumental device of claim 9, wherein the one or more brackets and the one or more keys are secured to the electronic device with a strap.

15. The haptic instrumental device of claim 9, wherein the one or more keys each define a hinge that flexes as the one or more keys are secured to the electronic device.

16. The haptic instrumental device of claim 9, wherein the one or more keys are arranged to emulate a key arrangement of one of an accordion, an air horn, a bagpipe, a bassoon, a clarinet, a flute, a French horn, an oboe, an ocarina, a pan flute, a piccolo, a trumpet, a trombone, or a tuba.

17. A method of operating a haptic instrumental device that includes the steps of:
providing one or more modules that each include one or more keys; and
attaching the one or more modules to an electronic device,
wherein the one or more keys include one or more capacitive nibs that are configured to contact a display screen of the electronic device to cause the electronic device to receive an input.

18. The method of claim 17 further comprising the step of:
providing a mouthpiece assembly; and
attaching the mouthpiece assembly to the electronic device.

19. The method of claim 18 further comprising the step of:
providing a reed holder within the mouthpiece assembly.

20. The method of claim 17, wherein the one or more capacitive nibs are made of a conductive plastic.
